(19) United States
(12) Patent Application Publication
(10) Pub. No.: US 2026/0316569 A1
(43) Pub. Date: Oct. 15, 2026

(54) INFORMATION PROCESSING DEVICE

(71) Applicant: TOYOTA JIDOSHA KABUSHIKI KAISHA, Toyota-shi (JP)

(72) Inventors: Takayuki YAMABE, Tokyo (JP); Aya YAMADA KAMISAKA, Tokyo (JP); Hajime TOJIKI, Tokyo (JP); Ryota NAKANISHI, Tokyo (JP); Kota HOSHIBA, Tokyo (JP)

(73) Assignee: TOYOTA JIDOSHA KABUSHIKI KAISHA, Toyota-shi (JP)

(21) Appl. No.: 19/542,904

(22) Filed: Feb. 18, 2026

(30) Foreign Application Priority Data
Apr. 14, 2025 (JP) 2025-066503

(51) Int. Cl. B60K 35/29; B60K 35/10

(52) U.S. Cl. CPC B60K 35/29; B60K 35/10; B60K 2360/195; B60K 2360/741

(57) ABSTRACT

An information processing device includes a control unit configured to: determine, based on data acquired from a first sensor provided in a vehicle, whether a first user who is a driver has exited the vehicle while an AI agent corresponding to the first user is output on a device that provides an interface between the AI agent and the first user; identify, based on data acquired from a second sensor, a second user who is one or more users different from the first user and is sitting in each seat of the vehicle; estimate a relationship or an intimacy level between the first user and the second user; and decide, based on the estimated relationship or the estimated intimacy level, whether to impose predetermined limitation on a content of information to be input to and output from the AI agent corresponding to the first user and being executed currently.

### CROSS-REFERENCE TO RELATED APPLICATION

This application claims priority to Japanese Patent Application No. 2025-066503 filed on Apr. 14, 2025. The disclosure of the above-identified application, including the specification, drawings, and claims, is incorporated by reference herein in its entirety.

### BACKGROUND

### 1. Technical Field

The present disclosure relates to information processing devices and the like that provide information via dialogue with a user.

### 2. Description of Related Art

There are technologies for carrying out dialogue with a user using natural language processing and providing information to the user based on the dialogue. In this regard, for example, Japanese Unexamined Patent Application Publication No. 2017-218032 (JP 2017-218032 A) discloses an in-vehicle device that, when no response to an alert is received from a vehicle occupant, determines the urgency of an abnormality in an in-vehicle situation, decides details of a process for the abnormality based on the urgency, and performs the process based on the decided details.

### SUMMARY

The present disclosure improves user privacy protection in dialogue carried out with a user in a vehicle using machine learning.

One aspect of the present disclosure is an information processing device configured to execute an artificial intelligence agent that is a virtual agent configured to carry out dialogue in natural language. The information processing device includes a control unit configured to: determine, based on data acquired from a first sensor provided in a vehicle, whether a first user who is a driver has exited the vehicle while the artificial intelligence agent corresponding to the first user is output on a device that provides an interface between the artificial intelligence agent and the first user; identify, based on data acquired from a second sensor provided in the vehicle, a second user who is one or more users different from the first user and is sitting in each seat of the vehicle; estimate a relationship or an intimacy level between the first user and the second user; and decide, based on the estimated relationship or the estimated intimacy level, whether to impose predetermined limitation on a content of information to be input to and output from the artificial intelligence agent corresponding to the first user and being executed currently.

Other aspects include an information processing method performed by the above information processing device, a program that causes a computer to perform the information processing method, and a computer-readable storage medium storing the program in a non-transitory manner.

The information processing device according to the present disclosure can improve user privacy protection in dialogue carried out with a user in a vehicle using machine learning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a network configuration including a server device according to a first embodiment;

FIG. 2 is a diagram illustrating components of the server device according to the first embodiment;

FIG. 3 is a flowchart of a process performed by the server device according to the first embodiment;

FIG. 4 is a flowchart of a process of estimating a relationship from a conversation according to a modification of the first embodiment; and

FIG. 5 is a flowchart of a process performed by a server device according to a second embodiment.

### DETAILED DESCRIPTION OF EMBODIMENTS

### Overview

There is a demand for a device that provides appropriate services to users based on natural language dialogue with the users.

In relation to this, there is a technology in which an in-vehicle terminal determines the urgency of an abnormality in an in-vehicle situation depending on whether there is a response from an occupant, and performs a process to address the abnormality decided based on the urgency.

For example, when the cabin temperature increases in the summer and a child is left alone in the cabin, it can be said that a highly urgent situation in which the child's safety is threatened has occurred. In such a case, it is expected that the child left behind cannot operate an air conditioner to reduce the cabin temperature. Therefore, the in-vehicle device needs to automatically operate the air conditioner. In view of this, a related-art in-vehicle device automatically operates the air conditioner when determination is made that the cabin temperature is equal to or higher than a reference value and a child is present alone in the cabin.

Specifically, the related-art in-vehicle device determines whether the cabin temperature is equal to or higher than the reference value when the vehicle engine is turned OFF. The in-vehicle device issues an alert when the cabin temperature is equal to or higher than the reference value and a person is detected in the cabin. Next, the in-vehicle device determines whether there is a response to the alert. When there is no response, the in-vehicle device ranks the current situation using various indices. When the in-vehicle situation is ranked such that immediate action is required, the in-vehicle device adjusts the cabin temperature.

However, there is room for improvement in the related-art in-vehicle device. Although the related-art in-vehicle device acquires a response from a user and decides a process to be performed , there is no sufficient consideration about the privacy of the user. The predetermined process to be performed by the in-vehicle device through the acquisition of the response from the user is not limited to the adjustment of the cabin temperature. For example, the in-vehicle device may execute an AI agent that is a virtual agent that carries out dialogue with a user using natural language processing, and provide a predetermined service based on a response from the user. In this case, if the predetermined service is provided uniformly to all users without distinction as in the related art, the following problem may occur. For example, when the user who has responded is different from the user who has an account for the currently executed AI agent, information related to the privacy of the user who has the account may be output in the predetermined service and may be known to the other user who has responded. Therefore, it is desirable that the information processing device limit the information to be input and output in the event of a situation in which a user other than the user who has the account for the AI agent responds to the AI agent.

An information processing device according to one aspect of the present disclosure is an information processing device configured to execute an AI agent that is a virtual agent configured to carry out dialogue in natural language. The information processing device includes a control unit configured to: determine, based on data acquired from a first sensor provided in a vehicle, whether a first user who is a driver has exited the vehicle while the AI agent corresponding to the first user is output on a device that provides an interface between the AI agent and the first user; identify, based on data acquired from a second sensor provided in the vehicle, a second user who is one or more users different from the first user and is sitting in each seat of the vehicle; estimate a relationship or an intimacy level between the first user and the second user; and decide, based on the estimated relationship or the estimated intimacy level, whether to impose predetermined limitation on a content of information to be input to and output from the AI agent corresponding to the first user and being executed currently.

The first user is the driver of the vehicle. The first user may have an account for use of the AI agent. While the first user is driving the vehicle, the AI agent is executed under the account of the first user.

The AI agent refers to a virtual agent that receives utterances or inputs from a user and carries out dialogue with the user through natural language processing. The virtual agent is implemented by a software program that provides a dialogue function with the user using natural language processing. The AI agent corresponding to the first user can learn dialogue with the first user.

The second user is one or more users sitting in each seat of the vehicle. The second user is a user different from the first user.

The relationship between the first user and the second user represents, for example, a relationship between the first user and the second user in terms of social life. For example, the relationship between the first user and the second user is a relationship in which the first user and the second user are a husband and a wife, a parent and a child, friends, colleagues, or a boss and a subordinate.

The intimacy level is a numerical value indicating the closeness between the first user and the second user. For example, the intimacy level may be expressed as a numerical value from 1 to 100. The intimacy level may be set higher than a predetermined value when the first user and the second user are in a husband-wife relationship, and may be set lower than the predetermined value when the first user and the second user are in a boss-subordinate relationship.

When the first user has exited the vehicle, the control unit decides whether to impose limitation on the content of the information to be input to and output from the currently executed AI agent based on the relationship or the intimacy level between the first user and the second user.

In this manner, the information processing device according to the present disclosure can adjust the content of the information to be input and output based on the relationship etc. between the first user and the second user when the first user is absent.

With this configuration, the information processing device according to the present disclosure can improve user privacy protection in dialogue with the user using machine learning.

The control unit may be configured to: acquire relationship information indicating the relationship between the first user and the second user; and estimate the relationship between the first user and the second user based on the relationship information.

Thus, the information processing device according to the present disclosure can identify the users riding in the vehicle and accurately estimate the relationship between them.

The control unit may be configured to: identify the second user based on voice in a conversation held between the first user and one or more of the second users in the vehicle; and estimate the intimacy level between the first user and the second user based on a result of analysis of a content of the conversation.

Thus, the information processing device according to the present disclosure can estimate the intimacy level between the users in real time.

The control unit may be configured to estimate the intimacy level based on an amount of speech made by the second user in the conversation.

Thus, the information processing device according to the present disclosure can accurately estimate the intimacy level between the users.

The control unit may be configured to, when the first user has exited the vehicle and the AI agent corresponding to the first user is being executed on the device that provides the interface, and when the estimated intimacy level is less than a predetermined value or the estimated relationship does not meet a predetermined condition, decide to impose the predetermined limitation on the content of the information to be input to and output from the AI agent corresponding to the first user.

Thus, the information processing device according to the present disclosure can avoid outputting information that is inappropriate for other users to know when the first user is absent.

Specific embodiments of the present disclosure will be described below with reference to the drawings. The hardware configuration, the module configuration, the functional configuration, etc. described in relation to the embodiments are not intended to limit the technical scope of the disclosure to only such embodiments unless otherwise specified.

### FIRST EMBODIMENT

### Overview of Process Performed by Server Device

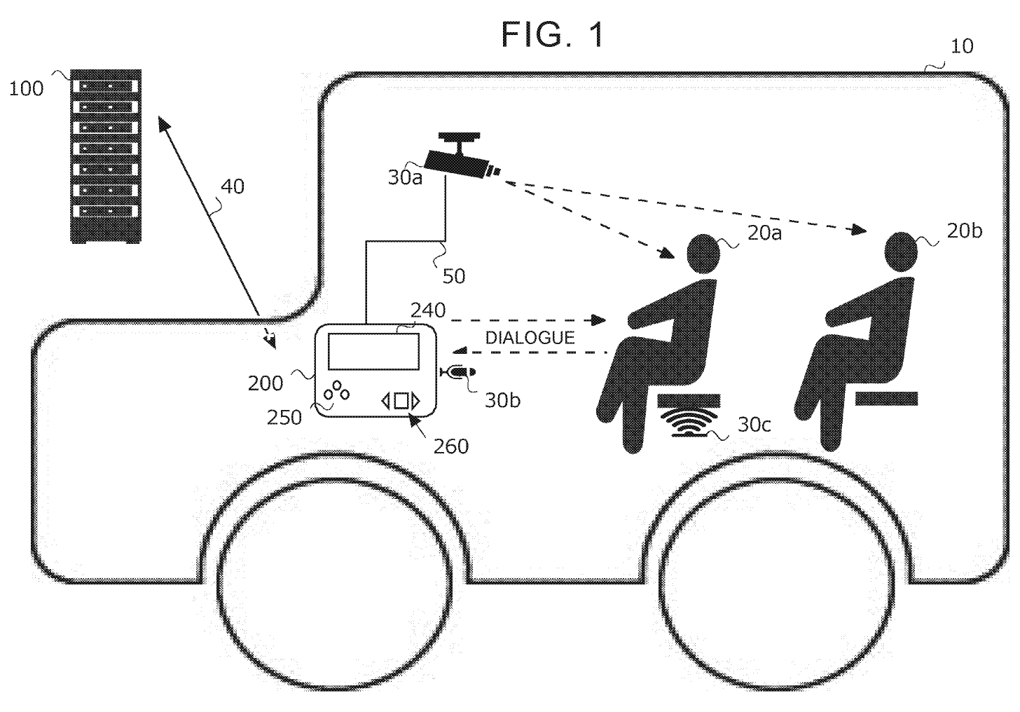

An overview of a network configuration including a server device according to a first embodiment will be described with reference to FIG. 1. FIG. 1 is a diagram showing a network configuration including a server device 100 according to the first embodiment. An information processing device according to one aspect of the present disclosure is implemented as the server device 100.

The server device 100 is an information processing device that provides appropriate information to a user 20 based on dialogue carried out with the user 20 using natural language processing that uses generative artificial intelligence (AI) etc. The server device 100 communicates with an in-vehicle terminal 200 via a communication network 40 that is a wide area network. Hereinafter, users 20a, 20b are collectively referred to as "user 20."

Typically, the user 20 is riding in a vehicle 10 and speaks to the in-vehicle terminal 200 that communicates with the server device 100. The server device 100 analyzes the utterance of the user 20 etc. acquired via the in-vehicle terminal 200 and generates a response corresponding to the meaning of the utterance. This process is performed by an AI agent corresponding to the user 20 and being executed by the server device 100. For example, the server device 100 reads the user's intent from the content of the user's utterance and generates an appropriate response. The natural language processing used to generate dialogue with the user 20 may instead be performed by the in-vehicle terminal 200. In that case, the in-vehicle terminal 200 is equipped with artificial intelligence such as generative AI.

The server device 100 acquires, from a camera 30a, a microphone 30b, etc. installed in the vehicle 10, information for identifying the user 20. The server device 100 acquires information from a seating sensor 30c installed in the vehicle 10 to determine whether the user 20 has exited the vehicle. Specifically, the camera 30a, the microphone 30b, or the seating sensor 30c transmits acquired information to a communication unit (described later) of the vehicle 10 via an in-vehicle network 50, and the communication unit of the vehicle 10 then transmits that information to the server device 100 via the communication network 40. In this manner, the information acquired by the camera 30a or the microphone 30b to identify the user 20 riding in the vehicle or the information acquired by the seating sensor 30c to determine whether the user 20 has exited the vehicle is transmitted to the server device 100.

For example, it is considered that determination is made that the user 20a and the user 20b are riding in the vehicle based on the information acquired by the camera 30a or the microphone 30b. When the user 20a is the driver, the server device 100 executes an AI agent corresponding to the account of the user 20a and provides it to the vehicle 10. When determination is made that the user 20a has exited the vehicle 10 based on the information acquired by the sensor 30, the server device 100 may impose limitation on the content of information to be input to and output from the currently executed AI agent.

### Configuration of Server Device

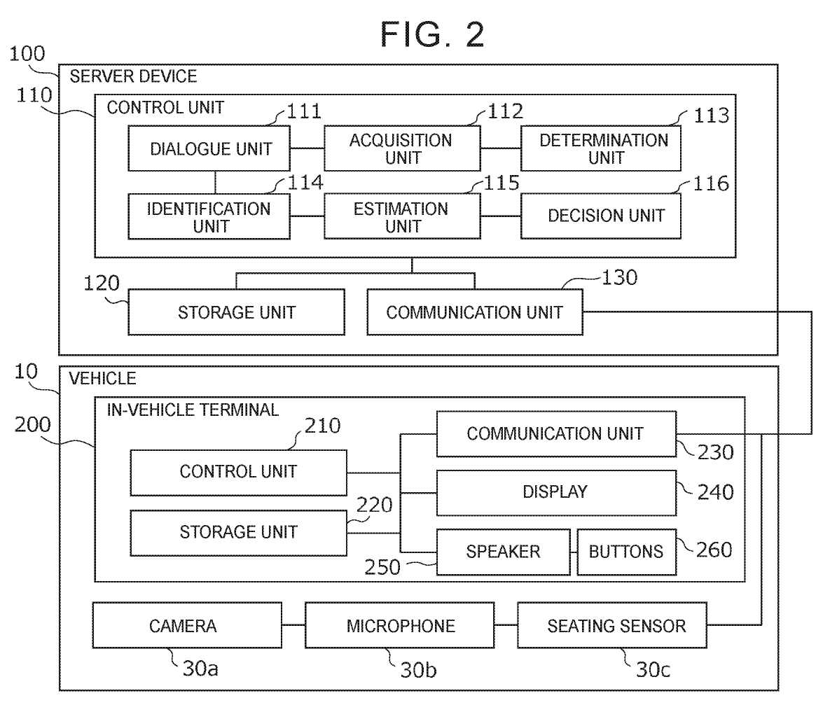

Next, the hardware and software configurations of the system including the server device 100 will be described. FIG. 2 is a diagram illustrating components of the server device 100 according to the first embodiment.

The server device 100 can be configured as a computer that includes a processor (such as a central processing unit (CPU) or a graphics processing unit (GPU)), a main storage device (such as a random access memory (RAM) or a read-only memory (ROM)), and an auxiliary storage device (such as an erasable programmable read-only memory (EPROM), a hard disk drive, or a removable medium). The auxiliary storage device stores an operating system (OS), various programs, various tables, etc. Various functions (software modules) for predetermined purposes, as described later, can be implemented by executing the programs stored in the auxiliary storage device. However, part or all of the functions may alternatively be implemented as hardware modules by using hardware circuits such as application-specific integrated circuits (ASICs) or field-programmable gate arrays (FPGAs).

The server device 100 includes a control unit 110, a storage unit 120, and a communication unit 130.

The control unit 110 is a processing unit that implements various functions of the server device 100 by executing predetermined programs. The control unit 110 can be implemented by a hardware processor such as a CPU. The control unit 110 may include a RAM, a ROM, and a cache memory.

In the present embodiment, the control unit 110 of the server device 100 includes six software modules: a dialogue unit 111, an acquisition unit 112, a determination unit 113, an identification unit 114, an estimation unit 115, and a decision unit 116. Each software module may be implemented by the control unit 110 (e.g., a CPU) executing programs stored in the storage unit 120. The information processing performed by the software modules is equivalent to the information processing performed by the control unit 110 (e.g., the CPU).

The dialogue unit 111 is a processing unit that carries out dialogue with the user 20 in natural language. The dialogue unit 111 executes an AI agent corresponding to the user 20, analyzes voice of the user 20 recognized by the microphone 30b or text input by the user 20, and generates a response corresponding to the meaning of the voice or text. The dialogue unit 111 can acquire information by communicating with the communication network 40 via the communication unit 130. The dialogue unit 111 outputs responses in the form of voice or text.

The acquisition unit 112 acquires data acquired by the camera 30a or the microphone 30b. The data acquired by the acquisition unit 112 is not limited to the above data as long as it is data for identifying the user 20 riding in the vehicle or data for estimating the relationship between the users 20 riding in the vehicle. Specifically, the acquisition unit 112 acquires an image captured by the camera 30a. Alternatively, the acquisition unit 112 may acquire audio acquired by the microphone 30b. The vehicle 10 may include a distance sensor that can detect motions of the user 20, and the acquisition unit 112 may acquire results indicating that the distance sensor detects the user 20 getting into the vehicle. The distance sensor may detect other motions of the user 20. The vehicle 10 may include a device that detects location information of the user 20, and the acquisition unit 112 may acquire the location information of the user 20 from that device. The location information of the user 20 may be location information obtained by a Global Navigation Satellite System (GNSS) for a terminal associated with the user 20.

The acquisition unit 112 acquires information from the seating sensor 30c to determine whether the user 20a has exited the vehicle. For example, the information for determining whether the user 20a has exited the vehicle may be a signal from the seating sensor 30c installed at least in the driver's seat of the vehicle 10. Alternatively, the acquisition unit 112 may acquire an image of the cabin of the vehicle 10 from the camera 30a as the information for determining whether the user 20a has exited the vehicle. Alternatively, the acquisition unit 112 may acquire voice data in the vehicle 10 from the microphone 30b as the information for determining whether the user 20a has exited the vehicle.

Based on the data acquired by the acquisition unit 112, the determination unit 113 determines whether the user 20a who is the driver has exited the vehicle while the AI agent corresponding to the user 20a is still being executed on the in-vehicle terminal 200.

The identification unit 114 identifies the user 20b who is one or more users sitting in the seats of the vehicle 10 other than the driver's seat based on the data acquired by the acquisition unit 112. The identification unit 114 identifies the user 20a sitting in the driver's seat based on the data acquired by the acquisition unit 112. For example, the identification unit 114 may analyze an image of the driver's seat acquired from the camera 30a to identify the user 20a sitting in the driver's seat. The identification unit 114 may then analyze images of the seats other than the driver's seat acquired from the camera 30a in a similar manner to identify the user 20b sitting in each seat other than the driver's seat. The identification unit 114 may identify which of the pre-registered persons corresponds to the person sitting in each seat of the vehicle 10 other than the driver's seat. Alternatively, the identification unit 114 may acquire individual user information indicating each person sitting in each seat of the vehicle 10 other than the driver's seat, and newly store the individual user information in the storage unit 120 (described later) in association with each seat.

The estimation unit 115 estimates a relationship or an intimacy level between the user 20a and the user 20b based on the data acquired by the acquisition unit 112. The relationship between the user 20a and the user 20b represents a relationship between the user 20a and the user 20b in terms of social life. The intimacy level between the user 20a and the user 20b is a numerical value indicating the degree of intimacy between the user 20a and the user 20b.

The decision unit 116 decides whether to impose predetermined limitation on the content of information to be input to and output from the currently executed AI agent corresponding to the user 20a based on the relationship or the intimacy level between the user 20a and the user 20b estimated by the estimation unit 115.

The storage unit 120 serves as means for storing information and is constituted by a storage medium such as a RAM, a magnetic disk, or a flash memory. The storage unit 120 stores programs to be executed by the control unit 110 and data to be used by those programs.

The communication unit 130 is a wireless communication interface for connecting the server device 100 to an external network. The communication unit 130 is configured to communicate with external devices via, for example, a wireless local area network (LAN) or a third-generation (3G), fourth-generation (4G), or fifth-generation (5G) cellular network.

The vehicle 10 is a vehicle capable of communicating with the communication network 40. The vehicle 10 may be a passenger car, or may be a large vehicle such as a bus or a truck. The vehicle 10 includes the sensor 30 and the in-vehicle terminal 200.

The camera 30a is an in-vehicle camera installed in the vehicle 10. The camera 30a is installed to capture images of at least the vehicle cabin. The camera 30a includes an imaging element such as a charge coupled device (CCD) or a complementary metal oxide semiconductor (CMOS). The camera 30a may be a monocular camera or a stereo camera.

The microphone 30b is a microphone installed in the vehicle 10. The microphone 30b includes a diaphragm (vibration plate), a back plate (fixed electrode), and an insulator (insulating material). The microphone 30b may be a dynamic (electrodynamic) microphone or a condenser (electrostatic) microphone.

The seating sensor 30c is a pressure sensor installed at least in the driver's seat of the vehicle 10. The seating sensor 30c is a sensor that outputs a signal when a weight of a predetermined amount or more is applied to the seat on which the seating sensor 30c is installed. The seating sensor 30c may be any sensor that can detect whether a person is sitting in the driver's seat, and may include, for example, a temperature sensor or an infrared sensor.

The in-vehicle terminal 200 is a terminal that receives operations performed by the user 20 of the vehicle 10 on various devices provided in the vehicle 10 and provides information to the user 20. The in-vehicle terminal 200 provides an interface between the user of the vehicle 10 and the AI agent. The in-vehicle terminal 200 includes a control unit 210, a storage unit 220, a communication unit 230, a display 240, a speaker 250, and buttons 260.

The control unit 210 receives input from the user 20 and transmits the input to the server device 100 via the communication unit 230. The control unit 210 outputs, via the display 240 or the speaker 250, text or audio indicating a response to the input, namely a response that has been transmitted from the server device 100.

The storage unit 220 serves as means for storing information and is constituted by a storage medium such as a RAM, a magnetic disk, or a flash memory. The storage unit 220 stores programs to be executed by the control unit 210 and data to be used by those programs.

The communication unit 230 is a wireless communication interface for connecting the in-vehicle terminal 200 to the communication network 40. The communication unit 230 is configured to communicate with external devices via, for example, a wireless LAN or a 3G, 4G, or 5G cellular network.

The display 240 is a display for presenting images and other information to the user. The display 240 may be a liquid crystal display or an organic electroluminescence (EL) display. The display 240 may also be implemented as a touch panel display.

The speaker 250 is a device that outputs audio for providing information to the user. The speaker 250 includes at least a voice coil, a magnet, and a cone. The speaker 250 may be a full-range speaker. The speaker 250 may be provided in the vehicle 10 as a car speaker, instead of being provided in the in-vehicle terminal 200.

The buttons 260 are devices that receive input from the user 20 to the in-vehicle terminal 200. The buttons 260 may be a plurality of projections that operates separately. The projections may receive different input contents. The buttons 260 may be, for example, buttons for moving a cursor upward, downward, rightward, or leftward, or for receiving input contents such as confirmation and cancellation. The buttons 260 may be graphics that function as buttons for receiving predetermined inputs and are displayed on the display 240 implemented as a touch panel.

The configuration shown in FIG. 2 is an example, and all or part of the functions shown in FIG. 2 may be executed using a specially designed circuit. The programs may be stored or executed using any combination of main and auxiliary storage devices other than those shown in the figure.

### Process Performed by Server Device

Next, the specific process performed by the server device 100 according to one aspect of the present disclosure will be described.

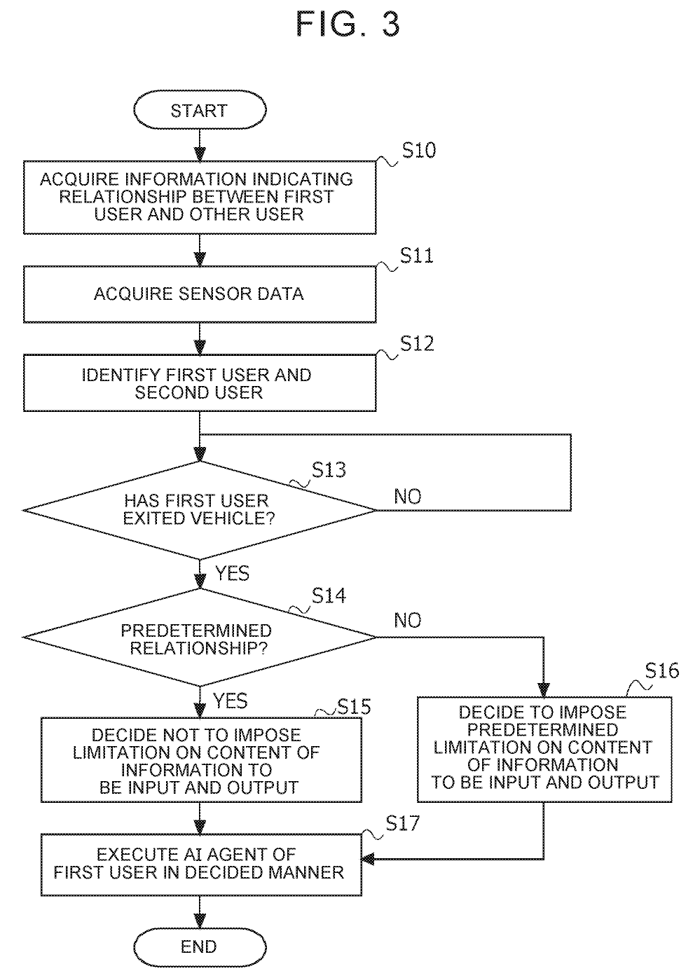

A process performed by the server device 100 to adjust information to be input to and output from the AI agent when the user 20a leaves the in-vehicle terminal 200 will be described. FIG. 3 is a flowchart of the process performed by the server device 100 according to the first embodiment. In the present embodiment, the process is performed when the AI agent of the driver (user 20a) is being executed on the vehicle 10. The user 20a is a specific example of a first user. The AI agent of the user 20a starts to be executed when the vehicle 10 starts traveling. Alternatively, the AI agent of the user 20a may start to be executed when an occupant gets in or out of the vehicle 10 or when a request is made to change the account of the currently executed AI agent.

First, in step S10, the acquisition unit 112 acquires relationship information indicating the relationship between the user 20a and another user. The relationship information is information indicating a relationship between the user 20a and another user in terms of social life. For example, the relationship information may indicate that the user 20a and another user are a married couple. Alternatively, the relationship information may indicate a boss-subordinate relationship between the user 20a and another user. There may be a plurality of other users, and the relationship information may be information in the form of a database that stores relationships between the other users and the user 20a. The acquisition unit 112 acquires the pre-registered relationship information at a predetermined timing.

Next, in step S11, the acquisition unit 112 acquires data acquired by the camera 30a or the microphone 30b to identify each user 20. For example, the acquisition unit 112 may acquire an image from the camera 30a. Alternatively, the acquisition unit 112 may acquire voice data in the vehicle 10 acquired by the microphone 30b. Alternatively, the acquisition unit 112 may communicate, via the communication unit 230 of the in-vehicle terminal 200, with mobile terminals respectively associated with the users 20 to acquire information for identifying each of the users 20.

Next, in step S12, the identification unit 114 identifies the user 20a and the user 20b present in the vehicle 10 based on the data acquired by the acquisition unit 112. The user 20b is a specific example of a second user. For example, the identification unit 114 may analyze images from the in-vehicle camera to identify the user 20a and the user 20b sitting in the seats. Specifically, the identification unit 114 may identify the user 20a based on an image of a person sitting in the driver's seat of the vehicle 10. The identification unit 114 may then identify the user 20b based on an image of a person sitting in a seat of the vehicle 10 other than the driver's seat.

Alternatively, the identification unit 114 may analyze voice acquired by the microphone 30b to identify the voiceprints of the user 20a and the user 20b, thereby identifying the user 20a and the user 20b sitting in the seats. Specifically, the identification unit 114 may analyze the voice acquired by the microphone 30b to identify the voiceprint contained in the voice acquired from the vicinity of the driver's seat of the vehicle 10, thereby identifying the user 20a. The identification unit 114 may then analyze the voice acquired by the microphone 30b to identify the voiceprint contained in the voice acquired from the vicinity of a seat of the vehicle 10 other than the driver's seat, thereby identifying the user 20b.

Alternatively, the identification unit 114 may identify the locations of the mobile terminals associated with the user 20a and the user 20b in the vehicle 10. The identification unit 114 may then identify the user 20a sitting in the driver's seat and the user 20b sitting in a seat other than the driver's seat from information acquired from the mobile terminals corresponding to the locations to identify the users associated with the mobile terminals.

Next, in S13, the determination unit 113 determines whether the user 20a has exited the vehicle 10 based on data acquired by the seating sensor 30c.

For example, the determination unit 113 may determine whether the user 20a has exited the vehicle 10 when no signal is received for a predetermined period from the seating sensor 30c provided in the driver's seat. The seating sensor outputs a signal when someone sits in the seat on which the seating sensor is installed. For example, the determination unit 113 may determine whether the user 20a has exited the vehicle 10 based on data detected by the distance sensor as to whether a person is sitting in the driver's seat. Specifically, the determination unit 113 may determine that the user 20a has exited the vehicle 10 when the distance sensor does not detect a person sitting in the driver's seat. For example, the determination unit 113 may determine whether the user 20a has exited the vehicle 10 based on the result of analysis of an image captured by the in-vehicle camera. Specifically, the determination unit 113 may determine that the user 20a has exited the vehicle 10 when a person sitting in the driver's seat is not detected in the image captured by the in-vehicle camera.

In this step, an affirmative determination is made when the determination unit 113 determines that the user 20a has exited the vehicle 10.

When an affirmative determination is made in step S13, the process proceeds to step S14.

When a negative determination is made in step S13, the process returns to step S13.

When the process proceeds to step S14, the estimation unit 115 determines whether the relationship between the user 20a and the user 20b is a predetermined relationship based on the relationship information acquired in step S10. The estimation unit 115 compares the result of identification of the user 20a and the user 20b in step S12 with the relationship information to determine the relationship between the user 20a and the user 20b. The predetermined relationship may be a certain degree of closeness between the user 20a and the user 20b. The predetermined relationship may be a relationship preset by the user 20a. For example, the estimation unit 115 determines that the user 20a and the user 20b are a married couple. In this step, an affirmative determination is made when the estimation unit 115 determines that the relationship between the user 20a and the user 20b is the predetermined relationship.

When an affirmative determination is made in this step, the process proceeds to step S15.

When a negative determination is made in this step, the process proceeds to step S16.

When the process proceeds to step S15, the decision unit 116 decides not to impose limitation on the content of information to be input to and output from the currently executed AI agent. For example, when the predetermined relationship is a close relationship with the user 20a like a family member of the user 20a, there is no need to conceal information related to the privacy of the user 20a. This is because, even if the information related to the privacy of the user 20a is input or output by the related user 20b in a space where the user 20a is not present, the user 20a may have no significant inconvenience. Alternatively, when the predetermined relationship is a relationship preset by the user 20a to allow information sharing, there is no need to conceal part or all of the information to be input to and output from the AI agent corresponding to the user 20a. Therefore, the decision unit 116 decides that the currently executed AI agent will input and output information under the same limitation as when the user 20a is sitting in the driver's seat.

When the process proceeds to step S17, the decision unit 116 decides to impose limitation on the content of information to be input to and output from the currently executed AI agent. For example, when the predetermined relationship is a relationship that is not very close to the user 20a like a colleague of the user 20a, it is necessary to conceal the information related to the privacy of the user 20a. This is because, when the information related to the privacy of the user 20a is input or output by the unrelated user 20b in a space where the user 20a is not present, the user 20a may have inconvenience. Alternatively, when the predetermined relationship is not the relationship preset by the user 20a to allow information sharing, it is necessary to conceal part or all of the information to be input to and output from the AI agent corresponding to the user 20a. Therefore, the decision unit 116 limits the input and output of information of a predetermined content in the currently executed AI agent. As described above, the information of the predetermined content may be the information related to the privacy of the user 20a. Alternatively, the information of the predetermined content may be information preset to limit input and output, in addition to the information related to the privacy of the user 20a.

Next, in step S17, the dialogue unit 111 executes the AI agent in the manner decided by the decision unit 116 in step S16 or step S17. The dialogue unit 111 carries out dialogue with the user 20b and other occupants through the AI agent in the decided manner.

As described above, the server device 100 of the present embodiment adjusts the information to be input to and output from the AI agent executed under the driver's account when the driver is absent. Thus, the server device 100 can improve user privacy protection in dialogue with the user using machine learning.

### Modification of First Embodiment

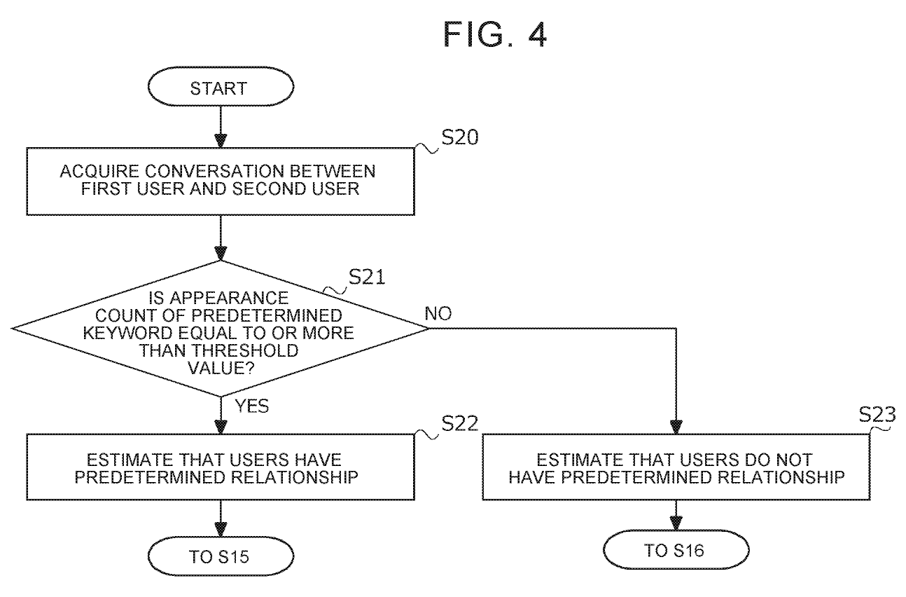

In the first embodiment, the server device 100 determines the relationship between the user 20a and the user 20b based on the relationship information. However, a user included in the pre-registered relationship information does not always get into the vehicle 10. Even in such a case, there may be a demand to estimate the relationship between the user present in the vehicle 10 and the driver. In the present modification, the server device 100 estimates the relationship between the user 20a and the user 20b based on a conversation between the user 20a and the user 20b that is held in the vehicle 10. FIG. 4 is a flowchart of a process of estimating the relationship from a conversation according to the modification of the first embodiment. The process illustrated in FIG. 4 is a concrete implementation of the process in step S15 of FIG. 3.

First, in step S20, the estimation unit 115 acquires a conversation between the user 20a and the user 20b. The estimation unit 115 acquires voice data in the vehicle 10 acquired by the microphone 30b, and extracts the conversation between the user 20a and the user 20b from the voice data.

Next, in step S21, the estimation unit 115 determines whether the appearance count of a predetermined keyword in the conversation between the user 20a and the user 20b is equal to or more than a predetermined threshold value. The estimation unit 115 may analyze, by text analysis, data obtained by converting the conversation between the user 20a and the user 20b into text, and measure the appearance count of the predetermined keyword.

When the estimation unit 115 determines that the appearance count of the predetermined keyword in the conversation between the user 20a and the user 20b is equal to or more than the predetermined threshold value, an affirmative determination is made in this step.

When an affirmative determination is made in this step, the process proceeds to step S22.

When a negative determination is made in this step, the process proceeds to step S23.

When the process proceeds to step S22, the estimation unit 115 estimates that the user 20a and the user 20b have the predetermined relationship. The predetermined relationship may be a certain degree of closeness between the user 20a and the user 20b. The predetermined relationship may be a relationship preset by the user 20a. For example, the estimation unit 115 may estimate that the user 20a and the user 20b are a married couple.

For example, the estimation unit 115 may determine that the user 20a and the user 20b are a married couple when the conversation between the user 20a and the user 20b includes words representing their first names at a frequency equal to or more than a predetermined threshold value. Alternatively, the estimation unit 115 may determine that the user 20a and the user 20b are a parent and a child when the conversation between the user 20a and the user 20b includes a word "father" or "mother" at a frequency equal to or more than a predetermined threshold value. After Step S22, the process proceeds to Step S15.

When the process proceeds to step S23, the estimation unit 115 estimates that the user 20a and the user 20b do not have the predetermined relationship. For example, the estimation unit 115 may estimate that the user 20a and the user 20b are not a married couple. After Step S23, the process proceeds to Step S16.

As described above, the server device 100 of the present modification estimates the relationship between the user 20a and the user 20b based on the conversation held in the vehicle. Thus, the server device 100 can estimate the relationship between the users 20 in a more realistic manner.

### Second Embodiment

In the first embodiment, the server device 100 estimates the relationship between the user 20a and the user 20b based on the relationship information acquired from the external device. However, there may be a case where the server device 100 does not include the user 20b in the relationship information and the relationship between the users is unclear. Even in such a case, the server device 100 may be able to estimate the intimacy level between the users by analyzing a conversation etc. acquired in real time. In the second embodiment, the server device 100 determines whether to limit the information to be input to and output from the AI agent executed under the driver's account based on the intimacy level between the user 20a and the user 20b.

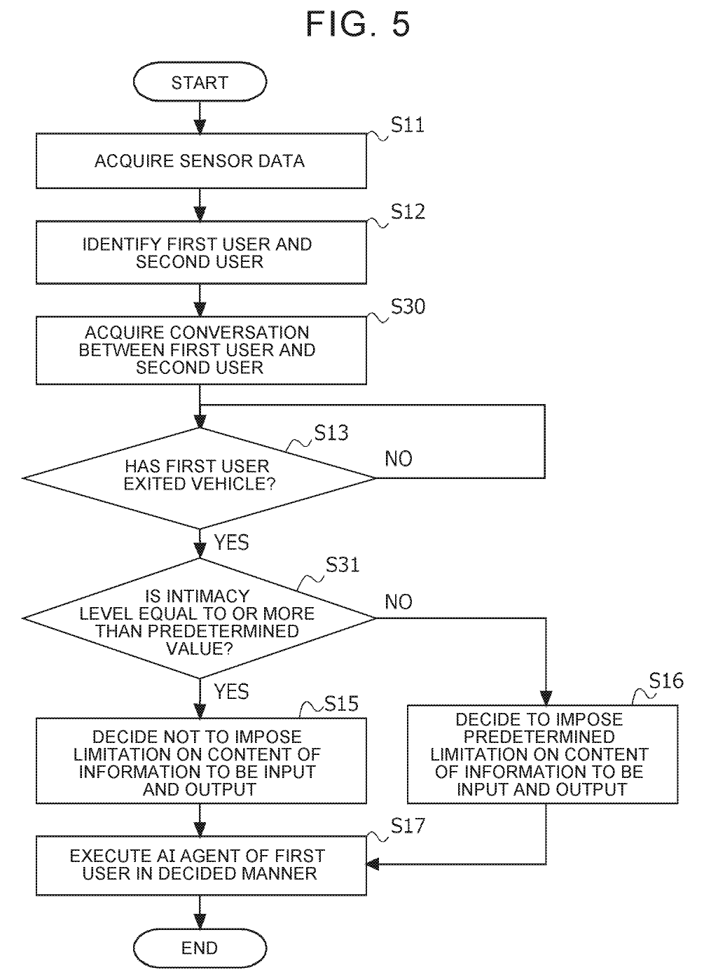

FIG. 5 is a flowchart of a process performed by the server device 100 according to the second embodiment. In FIG. 5, the same steps as those described with reference to FIG. 3 are denoted by the same reference signs as those in FIG. 3. The following description regarding FIG. 5 focuses on the steps different from those in FIG. 3. In the present embodiment, the process is performed when the AI agent of the driver (user 20a) is being executed on the vehicle 10. The user 20a is a specific example of the first user. The AI agent of the user 20a starts to be executed when the vehicle 10 starts traveling. Alternatively, the AI agent of the user 20a may start to be executed when an occupant gets in or out of the vehicle 10 or when a request is made to change the account of the currently executed AI agent.

After step S12 and before step S13, in step S30, the estimation unit 115 acquires voice data in the vehicle 10 acquired by the microphone 30b. The estimation unit 115 acquires the voice data in the vehicle 10 acquired by the microphone 30b, and extracts the conversation between the user 20a and the user 20b from the voice data.

After step S13, in step S31, the estimation unit 115 determines whether the intimacy level between the user 20a and the user 20b is equal to or more than a predetermined value. The intimacy level is a numerical value indicating the degree of intimacy between the user 20a and the user 20b. As the intimacy level increases, the numerical value may increase. For example, the intimacy level may be expressed as a numerical value from 1 to 100. The estimation unit 115 may analyze the acquired voice, calculate the amount of speech made by the user 20b, and determine that the intimacy level between the user 20a and the user 20b is equal to or more than the predetermined value when the amount of speech made by the user 20b is equal to or more than a predetermined amount. The amount of speech made by the user 20b may be expressed as the ratio of the time during which the user 20b has made the speech to the total time during which the conversation extracted from the voice continues.

In this step, an affirmative determination is made when the estimation unit 115 determines that the intimacy level between the user 20a and the user 20b is equal to or more than the predetermined value.

When an affirmative determination is made in this step, the process proceeds to step S15.

When a negative determination is made in this step, the process proceeds to step S16.

As described above, the server device 100 of the present embodiment determines whether to limit the information to be input to and output from the AI agent executed under the driver's account based on the intimacy level between the users 20 determined by analyzing the conversation between the users 20. Thus, the server device 100 can improve user privacy protection in dialogue with the user using machine learning even when a user who is not known in advance is present in the vehicle.

### Other Modifications

The embodiments described above are merely exemplary, and the present disclosure may be modified as appropriate without departing from the spirit and scope of the present disclosure. For example, the processes and means described in the present disclosure can be combined as desired as long as no technical contradiction occurs.

The above embodiments illustrate an example in which the information processing device of the present disclosure is the server device 100. However, the processes performed in the first embodiment, the modification of the first embodiment, and the second embodiment may alternatively be performed by the in-vehicle terminal 200. In the above case, the in-vehicle terminal 200 acquires the relationship information and the sensor data, estimates the relationship between the users 20 or the intimacy level between the users 20, executes the AI agent, and decides whether to impose limitation on the information to be input to and output from the AI agent. After the user 20a has exited the vehicle, the in-vehicle terminal 200 continues to execute the AI agent in accordance with the decision as to whether to impose limitation on the information to be input to and output from the AI agent.

In a case where the processes performed by the information processing device of the present disclosure in the first embodiment, the modification of the first embodiment, and the second embodiment are performed by the in-vehicle terminal 200, the in-vehicle terminal 200 acquires the relationship information from an external device through communication via the communication network 40.

The in-vehicle terminal 200 then identifies the user 20a and the user 20b based on data acquired from the camera 30a, the microphone 30b, etc. and executes the AI agent corresponding to the user 20a. When the in-vehicle terminal 200 determines that the user 20a has exited the vehicle 10, the in-vehicle terminal 200 estimates the relationship between the user 20a and the user 20b based on the relationship information. Based on the estimated relationship, the in-vehicle terminal 200 decides whether to impose limitation on the information to be input to and output from the currently executed AI agent, and executes the AI agent in the decided manner. The in-vehicle terminal 200 may estimate the relationship between the user 20a and the user 20b based on voice data of a conversation between the user 20a and the user 20b instead of the relationship information.

Alternatively, the in-vehicle terminal 200 identifies the user 20a and the user 20b based on data acquired from the camera 30a, the microphone 30b, etc., executes the AI agent corresponding to the user 20a, and then acquires voice data of a conversation between the user 20a and the user 20b. The in-vehicle terminal 200 then estimates the relationship between the user 20a and the user 20b based on the result of analysis of the voice data of the conversation. Based on the estimated relationship, the in-vehicle terminal 200 decides whether to impose limitation on the information to be input to and output from the currently executed AI agent, and executes the AI agent in the decided manner.

Part of the processes performed by the in-vehicle terminal 200, such as dialogue generation using a generative AI, may be performed by the server device 100, and the remaining processes described above may be performed by the in-vehicle terminal 200.

In the first embodiment, the acquisition unit 112 acquires the relationship information in step S10, but the acquisition unit 112 need not acquire the relationship information every time the process in the first embodiment is performed. The relationship information may be prestored in the storage unit 120 before the process described with reference to FIG. 3 is performed.

In the modification of the first embodiment, the estimation unit 115 determines that the relationship between the user 20a and the user 20b is the predetermined relationship when the appearance count of the predetermined keyword in the conversation is equal to or more than the predetermined threshold value, but the present disclosure is not limited thereto. The estimation unit 115 may determine that the relationship between the user 20a and the user 20b is the predetermined relationship when a predetermined criterion is met in terms of how the user 20a and the user 20b call each other in the conversation (e.g., whether they use honorifics), the amount of conversation, the choice of words, etc.

In the second embodiment, the estimation unit 115 may determine that the intimacy level is equal to or more than the predetermined value when the predetermined criterion is met in terms of how the user 20a and the user 20b call each other in the conversation (e.g., whether they use honorifics), the amount of conversation, the choice of words, etc.

The process described in the second embodiment may be performed in addition to the process described in the first embodiment when the relationship between the user 20a and the user 20b cannot be estimated in the first embodiment.

The present disclosure may be embodied such that a computer program that implements the functions described in the above embodiments is supplied to a computer and is read and executed by one or more processors of the computer. Such a computer program may be provided to the computer via a non-transitory computer-readable storage medium connectable to the system bus of the computer, or may be provided to the computer via a network. The non-transitory computer-readable storage medium may be, for example, any type of disk such as a magnetic disk (floppy (registered trademark) disk, hard disk drive (HDD), etc.) or an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read-only memory (EEPROM), a magnetic card, a flash memory, an optical card, or any type of medium suitable for storing electronic instructions.

What is claimed is:

1. An information processing device configured to execute an artificial intelligence agent that is a virtual agent configured to carry out dialogue in natural language, the information processing device comprising a control unit configured to:
determine, based on data acquired from a first sensor provided in a vehicle, whether a first user who is a driver has exited the vehicle while the artificial intelligence agent corresponding to the first user is output on a device that provides an interface between the artificial intelligence agent and the first user;
identify, based on data acquired from a second sensor provided in the vehicle, a second user who is one or more users different from the first user and is sitting in each seat of the vehicle;
estimate a relationship or an intimacy level between the first user and the second user; and
decide, based on the estimated relationship or the estimated intimacy level, whether to impose predetermined limitation on a content of information to be input to and output from the artificial intelligence agent corresponding to the first user and being executed currently.

2. The information processing device according to claim 1, wherein the control unit is configured to:
acquire relationship information indicating the relationship between the first user and the second user; and
estimate the relationship between the first user and the second user based on the relationship information.

3. The information processing device according to claim 1, wherein the control unit is configured to:
identify the second user based on voice in a conversation held between the first user and one or more of the second users in the vehicle; and
estimate the intimacy level between the first user and the second user based on a result of analysis of a content of the conversation.

4. The information processing device according to claim 3, wherein the control unit is configured to estimate the intimacy level based on an amount of speech made by the second user in the conversation.

5. The information processing device according to claim 1, wherein the control unit is configured to, when the first user has exited the vehicle and the artificial intelligence agent corresponding to the first user is being executed on the device that provides the interface, and when the estimated intimacy level is less than a predetermined value or the estimated relationship does not meet a predetermined condition, decide to impose the predetermined limitation on the content of the information to be input to and output from the artificial intelligence agent corresponding to the first user.
